(19) United States
(12) Patent Application Publication
(10) Pub. No.: US 2026/0267928 A1
(43) Pub. Date: Sep. 10, 2026

(54) AI Model Selection to Enrich Document Elements

(71) Applicant: Unstructured Technologies, Inc., Wilmington, DE (US)

(72) Inventors: Yao You, Houston, TX (US); Renyu Li, San Diego, CA (US); Crag Wolfe, San Jose, CA (US)

(21) Appl. No.: 19/069,233

(22) Filed: Mar. 4, 2025

(51) Int. Cl. G06F 16/93; G06F 16/906; G06F 40/30; G06V 30/413

(52) U.S. Cl. CPC G06F 16/93; G06F 16/906; G06F 40/30; G06V 30/413

(57) ABSTRACT

In one embodiment, a method includes determining, from an accessed document, a set of document elements representing the contents of the document, each document element having a classification label selected from a set of predefined document element labels. The method further includes determining, for each of one or more of the set of documents elements, whether to enrich the respective document element with output from an AI model; responsive to a determination to enrich the respective document element with output from an AI model, then selecting, based at least on the document element class label for the respective document element, a particular AI model to enrich the respective document element; receiving, from the selected AI model, the enriched output for the respective document element; and storing the enriched output in association with the document element in a database representing a corpus of documents that includes the accessed document.

### TECHNICAL FIELD

This application generally relates to AI model selection to enrich document elements.

### BACKGROUND

Information stored electronically is often used for retrieval and content generation. For example, a bank employee may want to look up information regarding bank guidelines for storing sensitive customer information, or an attorney preparing a merger agreement may want to start with a previous agreement to use as a template, rather than drafting the agreement from scratch. Information is often stored electronically in many different forms and in many different file formats, and information stored in an electronic file is generally referred to as a “document,” regardless of the format and form that the electronic file takes. Many entities store thousands of documents or millions of documents, and some store even more.

Accurate information retrieval and content generation can require information from one portion of a document, from multiple portions of a document, or even from multiple documents. Techniques that recognize text on a page, such as optical character recognition, may be used for storing text in searchable format, for example so that keyword searches may be run on documents, but such techniques rely on elementary language matching (e.g., searching for exact words or phrases, or for particular words that are within a particular distance from other words) and do not take into account semantic meaning of a document's contents. In addition, such techniques do not generate content (e.g., answers) from information contained in electronic documents.

### BRIEF DESCRIPTION OF THE DRAWINGS

FIG. 1 illustrates an example method for determining how document elements should be enriched.

FIG. 2 illustrates an example computing system.

### DESCRIPTION OF EXAMPLE EMBODIMENTS

Artificial intelligence (AI) technology can provide many types of assistance for users exploring a corpus of electronic documents. For example, large language models (LLMs) can receive natural-language queries (e.g., spoken or written queries) and can provide natural-language output based on the contents of documents in the corpus. For instance, LLMs can answer queries on the contents of documents, or generate a template for a particular kind of document from documents in a corpus. As another example, machine-learning models can be used to find many different kinds of patterns within a corpus of documents. AI assistance is revolutionary both in terms of the services it can provide (e.g., natural-language understanding and generation) and in its ability to provide information services on what can be a huge corpus of documents (e.g., a set of millions of documents).

However, creating a system that provides AI-assistance on a particular corpus of documents is a complex and difficult task. For example, for an LLM to answer queries on a user's corpus of documents, the LLM needs to semantically understand the contents of the documents in a way that corresponds to the information requested in the query. This is difficult for multiple reasons. For instance, documents take many different formats (e.g., spreadsheets, text-based documents, web-based documents, email documents, images, etc.), and different formats may define a document's contents very differently. Documents in a corpus therefore typically need to be normalized in a consistent way before an LLM can semantically understand the document's contents. In addition, a document's semantic meaning depends on what portion of the document is being considered, what content is in that portion, and how big that portion is.

For example, a 1,000+ page cookbook may generally describe techniques for preparing food. But that overview characterization of the entire cookbook is not useful for answering the specific question of “how does one make the top of a crème brûlée crunchy?” or “how long should I blanch broccoli for an antipasto salad?” Likewise, a document may contain different types of content, such as images, tables, and text, each of which provides information in different ways. For example, suppose a page of a cookbook textually and graphically describes a procedure for rolling bread dough. Asking “what information does this page show?” is a complex question that does not have a single answer, and both the text and images would need to be considered when providing an answer. In addition, both the portion of the page being considered and the relevancy of the information should be considered. For instance, “use a roller that has a light brown color” is unlikely to be relevant information for rolling bread dough, even if an image illustrates a light brown roller. Likewise, the portion or page being considered affects what information is being communicated. For example, a particular image and corresponding sentence that describes the need to sprinkle flour on the surface used to roll the dough provides more specific, but also more limited, information than would three full pages devoted to techniques for rolling bread dough.

Creating a robust system for AI-assisted tasks on a document corpus typically requires accessing the document corpus, splitting each document into portions (also referred to document chunks), and then computationally representing the semantic meaning within each document chunk. For instance, semantic meaning may be represented by embedding chunks, using any of a number of embedding approaches to represent the content in the chunk as a vector in an embedding space. These embeddings can then be stored in a database and accessed by an AI model during runtime for an AI-assisted task (e.g., to answer a user query on the document corpus).

However, actually implementing this process requires choosing among many different approaches and parameters values, each of which affects downstream performance on the AI-assisted tasks. As just one example, the choice of how and where to divide a document into chunks affects how those chunks are semantically understood by an embedding model. As another example, the choice of embedding model itself affects downstream task performance. Complicating this endeavor is the fact that accurate performance, and thus the corresponding approach to implement, varies based on the user's specific document corpus, and even on the specific task the user wishes to perform (e.g., information retrieval vs. content generation). And finally, creating a database from a document corpus that results in accurate run-time performance takes significant resources, including compute and monetary resources, and therefore using trial-and-error to test many different approaches for creating an AI-usable database from the document corpus is prohibitively expensive in terms of money, compute resources, and time.

This disclosure focuses on techniques for augmenting, or enriching, the information in a document corpus, thereby improving downstream AI-assisted tasks on that corpus. For instance, a document may contain text, images, and tables, and some of the content—particularly images and tables—may contain information that is not explicitly set forth in the document. If this information is not extracted and embedded, then an AI model (e.g., LLM) will not be able to take advantage of this information during runtime tasks, thereby decreasing task performance. In addition, many different approaches exist for enriching content in a document corpus, and the techniques described herein automatically identify particular enrichment tools that are customized to the specific content being augmented, to the tools' performance, and to the preferences of the particular user associated with a particular document corpus.

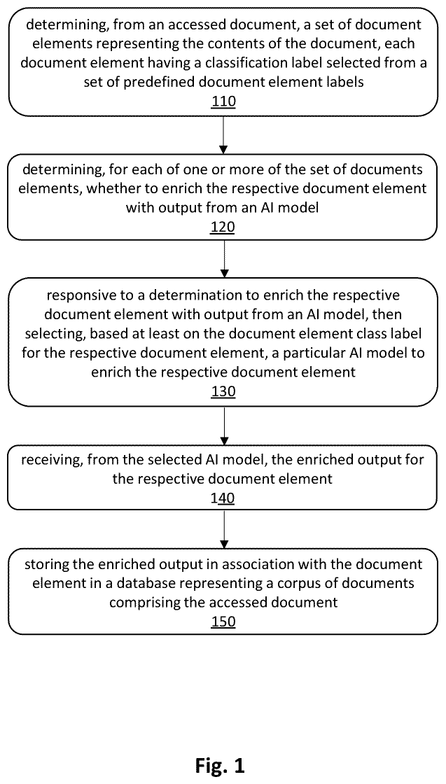

FIG. 1 illustrates an example method for determining how document elements should be enriched. Step 110 of the example method of FIG. 1 includes determining, from an accessed document, a set of document elements representing the contents of the document, each document element having a classification label selected from a set of predefined document element labels.

The accessed document is the corpus for performing AI evaluation, which is often natural-language question-and-answering on the corpus or AI-assisted information retrieval from the corpus. As discussed above, documents in a corpus may take many different file formats, and these file formats may define document elements differently, or may not define a document element at all.

In particular embodiments, step 110 of the example method of FIG. 1 may include parsing an accessed document into its elements, although this may performed prior to the example method of FIG. 1, in particular embodiments. For instance, a document in a corpus may be accessed and the constituent elements may be identified within the document. The definition of a particular element is predefined, typically by the administrator of the document-parsing system (e.g., by the entity performing the method of FIG. 1), and this definition is consistently applied across documents in the corpus. Identification of a document's constituent elements may be based on identifying portions of the documents, i.e., the elements, and then labelling those portions with an element classification label. Identifying a document's constituent elements may vary based on the file type used to represent the document. For example, in many instances, a bounding-box approach may be used, in which positions of a document are identified by a bounding box. The content within a bounding box corresponds to the element spatially defined by the bounding box's boundaries. A bounding box may take a rectangular shape, or may take a different shape more generally. Bounding boxes may overlap yet still contain different content within a document. For example, a text box may overlay a background image. The background image may be identified by a bounding box with borders that match the borders of the image, and the text box may be identified by a bounding box with borders that match the borders of the text box. The text-box bounding box is distinct from and separate from the image bounding box, even though the text bounding box is visually within the background-image bounding box.

For certain formats, bounding boxes may be natively identified. For example, the PDF format typically identifies bounding boxes for content with the PDF. In particular embodiment, other formats may be converted to a PDF format or an image format.

While a format may identify bounding boxes, a document element is defined by a classification label that corresponds to the content within a portion of the document (where the portion may correspond to a bounding box), and the definitions of these elements does not depend on the file format used. Instead, document elements are identified according to a consistent set of element definitions that exist apart from the file format used. Notably, an element's definition may not correspond to the semantic definition used by humans (e.g., a description of what visually constitutes a “table” or an “image”), but rather may be based on how AI tools parse a particular type of element (e.g., a definition of a “table” from the perspective of how an AI model determines what a “table” is).

In step 110 of the example of FIG. 1, elements in a document may be classified by a trained classifier. A set of ground-truth elements may be manually labeled according to the predetermined element definitions, and the set of labels is also predetermined. For example, a set of labels can include “text,” “handwriting,” “image,” “table,” “header,” “footer,” “page number,” “title,” etc., although other labels may also be used. The ground-truth examples and corresponding labels are used to train the classifier until a stopping condition is reached. The training results may be evaluated, for example using a confusion matrix, which may identify how well the predetermined set of classification labels works for labelling elements. For instance, the confusion matrix may identify that certain class labels should be merged, or that a class label should be split into multiple labels.

Once trained, the classifier receives as input some or all of an accessed document. For example, a classifier may receive a document on a page-by-page basis, although other divisions may be used. For each element identified in the classifier's input, the classifier assigns an element label. Thus, the accessed document is converted to a set of elements, each classified with a document-element label.

Step 120 of the example method of FIG. 1 includes determining, for each of one or more of the set of documents elements, whether to enrich the respective document element with output from an AI model. Enrichment refers to adding relevant information that is not explicitly within the document itself, based on the element (and, in particular embodiments, on any context, as described below). For example, a document may include an image of a motorcycle with a license plate bearing a particular license-plate number. An OCR system may identify the alphanumeric string in the license plate, but cannot identify the relevance of this alphanumeric string, i.e., that it is a license plate number for the motorcycle shown in the particular image element. However, this information may be incorporated into the embedded document corpus through enrichment by sending the image element, along with other data explained below, to an AI model. For instance, an AI model may be a large-language model (LLM) that can generate natural language in response to text, images, etc. Other examples of AI models include multimodal models, such as Multimodal Large Language Models (MLLMs) and Vision-Language Models (VLMs). As another example, enrichment can include summaries (e.g., summarizing the contents of a table). As a result of enrichment, AI-assisted tasks (e.g., query responses) can provide better results on the contents of a corpus of documents, because the embedded document database includes enriched information that is not explicitly set forth in the documents, and which would not be captured without enrichment.

While in theory enrichment may always be useful, and so every element may be selected for enrichment, in practice enrichment results are very sensitive to the model being selected to provide enrichment, to the content being enriched, and to the costs associated with enrichment. For example, it can be very expensive (both monetarily and in terms of compute resources) to send every element in a document for enrichment, particularly when working on a large corpus (e.g., thousands or millions) of documents. Thus, step 120 of the example method of FIG. 1 includes determining whether to enrich a document element. The decision about whether to enrich a document element may be based on several factors. For example, an element's classification label may inform whether to enrich an element. For instance, non-text elements may be enriched, while text elements may not be enriched. As another example, the size of the element may be used to determine whether to enrich, e.g., a large section of text may be a good candidate for summary enrichment, while an element that consists of a few sentences may not be. As another example, the cost associated with enrichment, along with related factors such as the number of elements or the size of the document corpus, may be used to determine whether to enrich certain elements. For example, a total number of elements or a percentage of elements may be used to determine how many elements will be sent for enrichment (i.e., by placing a cap on the number of elements that will be enriched). These factors may be determined by the end user of the document corpus.

Step 130 of the example method of FIG. 1 includes responsive to a determination to enrich the respective document element with output from the AI model, then selecting, based at least on the document element class label for the respective document element, a particular AI model to enrich the respective document element. In practice, many different AI architectures exist for providing output in response to some input content, and these models vary in how they perform on enrichment tasks. In fact, a particular architecture (e.g., ChatGPT) can vary in performance from version to version of that architecture. Performance can also depend on the type of content and the requested task, as some models are better suited to, e.g., summarize information while other models are better suited to creating natural-language descriptions of visual information, such as images.

In the example of FIG. 1, selection of a particular AI model is based at least on the class label given to an element, for example by the trained classifier discussed above. This reflects that fact that enrichment is not a one-size-fits-all exercise; different AI models are different tools with different capabilities, and the type of content being enriched (e.g., image vs. table vs. text) will influence which model is best suited to enrich a particular content element.

Determining which model to select may be based on performance analysis of existing model options with respect to the document element(s) to be enriched. For example, a model cascade may be used, in which a classifier is trained to select a particular AI model to use for enrichment based on ground-truth training pairs of elements and corresponding particular AI models that are available for selection. In particular embodiments, the contents of the elements themselves may be used (in addition to the element label) to determine which particular model to use for enrichment. Here, basing an enrichment decision on an element label can include basing the decision on the label proper (e.g., on the fact that an element has the “image” label) or on corresponding information (e.g., that an element is an image, and therefore corresponds to the “image” label).

Model performance data, such as performance data for a particular AI model to select for a particular element in a database of ground-truth pairs, may be based on analyses of how available models have performed on training data. In particular embodiments, performance data may include analysis of the output provided by a particular model in response to an input. For example, performance data may include an analysis of how accurate, or how complete, a description of an image is or a summary of a table is. In particular embodiments, this performance may be evaluated relative to the specific task requested to be performed, for example in a prompt accompanying the respective document element. For instance, if a prompt requires a short description of an image, then a model's ability to provide a short description can play a role in performance evaluation, even if the model otherwise provides accurate (but overly long) natural-language output.

In particular embodiments, performance may be based not only on a model's output in response to a particular element input, but also on the downstream question of how a model's enrichments affect the ultimate goal, which is to perform AI tasks on the document corpus. For example, a model may be evaluated on how well a user is able to receive accurate query responses on an enriched corpus of documents. These results may themselves be affected by the user's choice of AI model to use to perform the queries; in other words, an AI model's enrichment performance may be influenced by, and targeted to, a user's choice of model for the ultimate AI-assisted task in a particular instance. This example illustrates how model selection for enrichment is often more than simply asking how models perform on their immediate enrichment tasks, but rather on how a model's enrichment influences downstream task performance, which can involve how well models work together. In particular embodiments, model performance may be updated periodically (e.g., as new models or new versions of models are released).

In particular embodiments, selection of an AI model may be based on available resources. For example, a model's availability to perform enrichment in a particular timeframe may be a factor in deciding which particular AI model to use to enrich a particular document element. As another example, the processing or monetary cost associated with a model's performance may be a factor in deciding which model to use. For example, some models may provide robust image description at the cost of 1 cent per image, while another model may provide lesser performance but at the cost of a 1/10 of a cent per image. The particular approach may be determined by the end user (e.g., the entity) who will perform AI-assisted tasks on the document corpus; for example, the end user may specific a per-element cost limit or may specify a total budget, so that enrichment selections are made based on how many elements will (or are projected to be) enriched and the associated cost per element.

Step 140 of the example method of FIG. 1 includes receiving, from the selected AI model, the enriched output for the respective document element. For instance, the respective document element may be sent to the selected AI model. Other information may be sent, as well; for example, a prompt and/or contextual information may be sent to the AI model and may influence the enriched output from the AI model. The enriched output is typically text (e.g., a textual description of an image, a summary of a block of text, a caption for a table, etc.), but may take other forms (e.g., may be an image, a video, or audio created by an AI model based on the particular, respective document element being enriched).

A prompt is a set of instructions, typically used with a LLM, to tune the LLM on the task at hand. Here, prompts may be submitted to a selected AI model to influence the enrichment task performed by the selected model. In particular embodiments, a prompt may not be needed if the model is already tuned specifically to the enrichment task. In particular embodiments, prompts may be tailored to the particular selected AI model, or even to the particular enrichment task. For instance, selecting a particular AI model to use for a particular, respective document element may then be followed by selecting a particular prompt to send to the selected AI model. The prompt selection process may depend on the selected model and, in particular embodiments, the enrichment task. In particular embodiments, a prompt for a particular task or model may be updated as new versions of existing AI models are released. In particular embodiments, prompts accompanying a document element for enrichment may be structured to the particular element definitions and classification labels used in step 110 and described above.

In particular embodiments, a context may also be sent to a particular selected AI model for the particular, respective document element being enriched. Context refers to other document elements (i.e., not the respective document element being enriched) that are relevant to enriching the respective document element. Relevant context may be determined based on the spatial nearness between document elements, for example as determined based on the coordinates associated with each element's bounding box. In particular embodiments, nearness may be determined geometrically (e.g., based on a straight-line distance), determined by reading order (e.g., content at the top of first column of a two-column page is nearer to content at the bottom of the first column than to content at the top of the second column, even though content at the top of a first column may be spatially very near content at the top of a second column), or other distance metrics. In particular embodiments, relevant context may depend on an element's class label. For example, an element labeled as a “page number” is typically not relevant context for an image on that page.

Context may be used to improve enrichment results, and the inclusion of context can depend on the content of the element being enriched and/or on the content of the context, and the relationship between the two. For example, if a table is the element being enriched, then context may include text in a nearby bounding box that is identified, by its element label, as a table caption. As another example, an image identified in a document as “FIG. 3” may be enriched with context that includes document elements that contain content describing FIG. 3 of that document.

Step 150 of the example method of FIG. 1 includes storing the enriched output in association with the document element in a database representing a corpus of documents that includes the accessed document. Many different kinds of databases may be used by end users for performing AI-assisted tasks on that users' corpus of documents. For example, vector-based databases are often used, in which content is vectorized and embedded into an n-dimensional space. As another example, relational databases may be used. As another example, blob storage may be used. The enriched content output from the AI model is associated with the respective document element so that the enrichment can be used during AI-assisted tasks. For instance, an enrichment describing an image may be associated with that image in the database. In embodiments that use a vector-based database, text-based enriched output may be vectorized and embedded into the n-dimensional space.

As a result of the techniques described herein, a corpus of documents can be enriched, or augmented, with content that is not explicitly set forth in the document but is useful in improving the performance of AI-assisted tasks. In particular, the technique described herein intelligently select an AI model to use for enrichment on an element-by-element basis, so that the enrichment is tailored to the particular content being enriched and to the end user's ultimate use of the AI-assisted tasks.

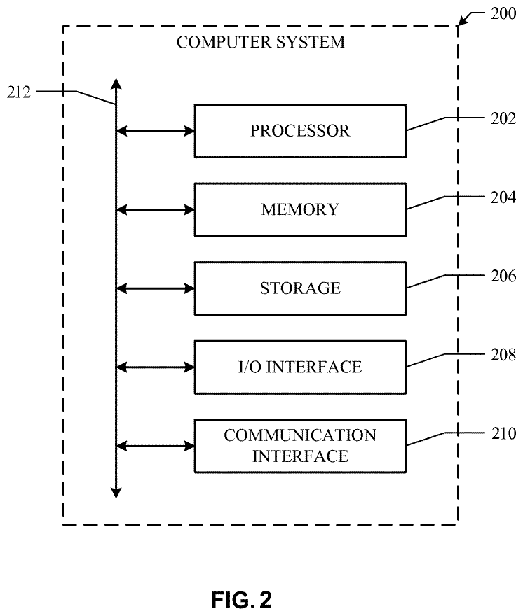

FIG. 2 illustrates an example computer system 200. In particular embodiments, one or more computer systems 200 perform one or more steps of one or more methods described or illustrated herein. In particular embodiments, one or more computer systems 200 provide functionality described or illustrated herein. In particular embodiments, software running on one or more computer systems 200 performs one or more steps of one or more methods described or illustrated herein or provides functionality described or illustrated herein. Particular embodiments include one or more portions of one or more computer systems 200. Herein, reference to a computer system may encompass a computing device, and vice versa, where appropriate. Moreover, reference to a computer system may encompass one or more computer systems, where appropriate.

This disclosure contemplates any suitable number of computer systems 200. This disclosure contemplates computer system 200 taking any suitable physical form. As example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 200 may include one or more computer systems 200; be unitary or distributed; span multiple locations; span multiple machines; span multiple data centers; or reside in a cloud, which may include one or more cloud components in one or more networks. Where appropriate, one or more computer systems 200 may perform without substantial spatial or temporal limitation one or more steps of one or more methods described or illustrated herein. As an example and not by way of limitation, one or more computer systems 200 may perform in real time or in batch mode one or more steps of one or more methods described or illustrated herein. One or more computer systems 200 may perform at different times or at different locations one or more steps of one or more methods described or illustrated herein, where appropriate.

In particular embodiments, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In particular embodiments, processor 202 includes hardware for executing instructions, such as those making up a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. In particular embodiments, processor 202 may include one or more internal caches for data, instructions, or addresses. This disclosure contemplates processor 202 including any suitable number of any suitable internal caches, where appropriate. As an example and not by way of limitation, processor 202 may include one or more instruction caches, one or more data caches, and one or more translation lookaside buffers (TLBs). Instructions in the instruction caches may be copies of instructions in memory 204 or storage 206, and the instruction caches may speed up retrieval of those instructions by processor 202. Data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data. The data caches may speed up read or write operations by processor 202. The TLBs may speed up virtual-address translation for processor 202. In particular embodiments, processor 202 may include one or more internal registers for data, instructions, or addresses. This disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In particular embodiments, memory 204 includes main memory for storing instructions for processor 202 to execute or data for processor 202 to operate on. As an example and not by way of limitation, computer system 200 may load instructions from storage 206 or another source (such as, for example, another computer system 200) to memory 204. Processor 202 may then load the instructions from memory 204 to an internal register or internal cache. To execute the instructions, processor 202 may retrieve the instructions from the internal register or internal cache and decode them. During or after execution of the instructions, processor 202 may write one or more results (which may be intermediate or final results) to the internal register or internal cache. Processor 202 may then write one or more of those results to memory 204. In particular embodiments, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere). One or more memory buses (which may each include an address bus and a data bus) may couple processor 202 to memory 204. Bus 212 may include one or more memory buses, as described below. In particular embodiments, one or more memory management units (MMUs) reside between processor 202 and memory 204 and facilitate accesses to memory 204 requested by processor 202. In particular embodiments, memory 204 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 204 may include one or more memories 204, where appropriate. Although this disclosure describes and illustrates particular memory, this disclosure contemplates any suitable memory.

In particular embodiments, storage 206 includes mass storage for data or instructions. As an example and not by way of limitation, storage 206 may include a hard disk drive (HDD), a floppy disk drive, flash memory, an optical disc, a magneto-optical disc, magnetic tape, or a Universal Serial Bus (USB) drive or a combination of two or more of these. Storage 206 may include removable or non-removable (or fixed) media, where appropriate. Storage 206 may be internal or external to computer system 200, where appropriate. In particular embodiments, storage 206 is non-volatile, solid-state memory. In particular embodiments, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form. Storage 206 may include one or more storage control units facilitating communication between processor 202 and storage 206, where appropriate. Where appropriate, storage 206 may include one or more storages 206. Although this disclosure describes and illustrates particular storage, this disclosure contemplates any suitable storage.

In particular embodiments, I/O interface 208 includes hardware, software, or both, providing one or more interfaces for communication between computer system 200 and one or more I/O devices. Computer system 200 may include one or more of these I/O devices, where appropriate. One or more of these I/O devices may enable communication between a person and computer system 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 208 for them. Where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In particular embodiments, communication interface 210 includes hardware, software, or both providing one or more interfaces for communication (such as, for example, packet-based communication) between computer system 200 and one or more other computer systems 200 or one or more networks. As an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it. As an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 200 may include any suitable communication interface 210 for any of these networks, where appropriate. Communication interface 210 may include one or more communication interfaces 210, where appropriate. Although this disclosure describes and illustrates a particular communication interface, this disclosure contemplates any suitable communication interface.

In particular embodiments, bus 212 includes hardware, software, or both coupling components of computer system 200 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 212 may include one or more buses 212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

1. A method comprising:
determining, from an accessed document, a set of document elements representing the contents of the document, each document element having a classification label selected from a set of predefined document element labels;
determining, for each of one or more of the set of documents elements, whether to enrich the respective document element with output from an AI model;
responsive to a determination to enrich the respective document element with output from an AI model, then selecting, based at least on the document element class label for the respective document element, a particular AI model to enrich the respective document element;
generating, for the respective document element, an enriched output comprising electronic content that is not present in the respective document element by:
transmitting at least the respective document element to the selected AI model;
receiving, from the selected AI model, the enriched output for the respective document element; and
storing the enriched output in association with the document element in (1) a database representing a corpus of documents comprising the accessed document and (2) an electronic format accessible by an AI technology during an AI-assisted task.

2. The method of claim 1, wherein determining the set of document elements comprises classifying each element in the document by a trained classifier.

3. The method of claim 1, further comprising selecting, based at least on the document element class label for the respective document element and on a resource usage associated with the particular AI model, the particular AI model to enrich the respective document element.

4. The method of claim 1, further comprising sending, to the selected AI model, a prompt specific to the selected AI model.

5. The method of claim 1, further comprising sending, to the selected AI model, one or more context elements identified as semantically related to the respective document element.

6. The method of claim 5, wherein each of the one or more context elements are identified as semantically related based on a spatial proximity, in the document, between that context element and the respective document element.

7. The method of claim 1, wherein the AI model comprises an LLM, and the enriched output comprises text.

8. The method of claim 1, wherein the enriched output comprises one or more of (1) a description of an image corresponding to the respective document element, or (2) a summary of the content in the respective document element.

9. The method of claim 1, further comprising selecting, based at least on the document element class label and on model performance data, the particular AI model to enrich the respective document element.

10. One or more non-transitory computer readable storage media storing instructions that are operable when executed to:
determine, from an accessed document, a set of document elements representing the contents of the document, each document element having a classification label selected from a set of predefined document element labels;
determine, for each of one or more of the set of documents elements, whether to enrich the respective document element with output from an AI model;
responsive to a determination to enrich the respective document element with output from an AI model, then select, based at least on the document element class label for the respective document element, a particular AI model to enrich the respective document element;
generate, for the respective document element, an enriched output comprising electronic content that is not present in the respective document element, by:
transmitting at least the respective document element to the selected AI model;
receiving, from the selected AI model, the enriched output for the respective document element; and
storing the enriched output in association with the document element in (1) a database representing a corpus of documents comprising the accessed document and (2) an electronic format accessible by an AI technology during an AI-assisted task.

11. The media of claim 10, wherein determining the set of document elements comprises classifying each element in the document by a trained classifier.

12. The media of claim 10, wherein the instructions are further operable when executed to select, based at least on the document element class label for the respective document element and on a resource usage associated with the particular AI model, the particular AI model to enrich the respective document element.

13. A system comprising one or more non-transitory computer readable storage media storing instructions; and one or more processors coupled to the one or more non-transitory computer readable storage media and operable to execute the instructions to:
determine, from an accessed document, a set of document elements representing the contents of the document, each document element having a classification label selected from a set of predefined document element labels;
determine, for each of one or more of the set of documents elements, whether to enrich the respective document element with output from an AI model;
responsive to a determination to enrich the respective document element with output from an AI model, then select, based at least on the document element class label for the respective document element, a particular AI model to enrich the respective document element;
generate, for the respective document element, an enriched output comprising electronic content that is not present in the respective document element, by:
transmitting at least the respective document element to the selected AI model;
receiving, from the selected AI model, the enriched output for the respective document element; and
storing the enriched output in association with the document element in (1) a database representing a corpus of documents comprising the accessed document and (2) an electronic format accessible by an AI technology during an AI-assisted task;
access a query from a user regarding the corpus of documents; and
determine, based on the enriched output in the database and by a trained AI model, a response to the query.

14. The system of claim 13, wherein determining the set of document elements comprises classifying each element in the document by a trained classifier.

15. The system of claim 13, further comprising one or more processors operable to execute the instructions to select, based at least on the document element class label for the respective document element and on a resource usage associated with the particular AI model, the particular AI model to enrich the respective document element.

16. The system of claim 13, where further comprising one or more processors operable to execute the instructions to send, to the selected AI model, a prompt specific to the selected AI model.

17. The system of claim 13, further comprising one or more processors operable to execute the instructions to send, to the selected AI model, one or more context elements identified as semantically related to the respective document element.

18. The system of claim 17, wherein each of the one or more context elements are identified as semantically related based on a spatial proximity, in the document, between that context element and the respective document element.

19. The system of claim 13, wherein the output from the AI model comprises output from an LLM, and the enriched output comprises text.

20. The system of claim 13, wherein the enriched output comprises one or more of (1) a description of an image corresponding to the respective document element, or (2) a summary of the content in the respective document element.
